(19) United States
(12) Patent Application Publication
(10) Pub. No.: US 2022/0414526 A1
(43) Pub. Date: Dec. 29, 2022

(54) INTELLIGENT FAULT DETECTION SYSTEM

(71) Applicant: Intelligent Systems, LLC, Nashville, TN (US)

(72) Inventors: Timothy Darrah, Nashville, TN (US); Teddy Dinker, Nashville, TN (US); Joseph Kuryla, Nashville, TN (US)

(21) Appl. No.: 17/356,495

(22) Filed: Jun. 23, 2021

(51) Int. Cl. G06N 20/00; G06F 16/23; G05B 23/02; G05B 19/042; F24F 11/64; F24F 11/38; F24F 11/52

(52) U.S. Cl. CPC G06N 20/00; G06F 16/2379; G05B 23/0283; G05B 19/042; F24F 11/64; F24F 11/38; F24F 11/52; G05B 2219/2614; F24F 2110/66

(57) ABSTRACT

The systems and methods described herein provide for a novel deep learning approach to estimating and predicting faulty mechanical system conditions before they occur without using any measurements from the system itself. Environmental data, such as temperature, humidity, occupancy, volatile organic compounds (VOC), equivalent carbon dioxide (eCO2) and particulate matter may be used in the estimation and prediction of faults, failures, and other inefficiencies within the HVAC system.

### BACKGROUND

The broader impacts of this technology directly address occupant health and indoor air quality. People spend roughly ⅓ of their life in a facility environment where the air quality is directly impacted by the health of the mechanical systems that circulate the air. Several studies have shown that poor air quality results in increased health problems, more doctor visits, productivity loss, and reduced learning outcomes. It also costs the U.S. economy over $30B a year in medical expenses alone. Recently it has been shown that COVID-19 transmits more easily in poorly ventilated environments as well.

Existing building automation system leaders and other competitors are currently focusing on energy optimization and ignoring the link between IAQ, occupant health, HVAC performance, and transmission of aerosolized viruses or pathogens.

Dominant industry beliefs falsely assume that building automation systems properly control building environments 24/7, ensure that indoor air quality (IAQ) is maximized, and mechanical systems operate efficiently. In reality, those systems solely focus on the operation of proprietary mechanical equipment to reduce energy costs and rely on building occupants themselves to monitor and report on actual environmental conditions. These observations must be manually communicated through work-order protocols and prioritized manually through dispatch procedures. The conditions must then be verified by trained maintenance personnel and diagnosed. Diagnosis is limited to observable data available through manual investigation and post-condition data collection, which is oftentimes not reliable and leads to longer repair times.

Typically, it is expected that the building automation systems monitor the HVAC equipment, which represents a facility's largest recurring expense, and report when faults occur. However, equipment repeatedly fails without warning and often times several hours or days pass before the failure is noticed or addressed. This results in a cascading effect of paying premium price for expedited parts and emergency repairs, loss of productivity, and unhappy building occupants.

Current approaches to fault monitoring of mechanical systems focus on individual components, such as the air handling unit only, or cooling tower only, etc., and rely on supervised approaches to the fault detection. These methods require labeled data, and all use numerous sensor measurements taken directly from the mechanical system. Currently, the majority of these methods remain artifacts of university research, and have yet to transition to widespread commercial use.

### SUMMARY

The systems and methods described herein provide for a novel deep learning approach to estimating and predicting faulty mechanical system conditions before they occur without using any measurements from the system itself. Environmental data, such as temperature, humidity, occupancy, volatile organic compounds (VOC), equivalent carbon dioxide (eCO2) and particulate matter may be used in the estimation and prediction of faults, failures and other inefficiencies within the HVAC system.

The systems and methods described herein may be applied to an entire mechanical system, not just single components. In some embodiments, no system component sensor data is used, only environmental data collected from environmental sensor located throughout one or more rooms in one or more buildings. The environmental sensors may be located externally from the HVAC machinery, and positioned within the one or more rooms.

In some embodiments, elements of multivariate, multistep (patterns at multiple timescales) time-series analysis as well as supervised and semi-unsupervised learning may be used in the analysis of sensor data as well as estimation and prediction of machine faults and failures. In some embodiments, in order to have a sufficient amount of information to train the models, the system may also implement a unique method of generating synthetic observations from limited real-world data regarding faulty conditions and air quality issues.

In some embodiments, various deep learning architectures, online stochastic simulation, and a human-in-the-loop component may be combined to create a robust framework that can identify mechanical system and indoor air quality (IAQ) issues before they become major failures.

In some embodiments, the system may provide for intelligent alerting and a predictive system that measures the IAQ and detects poorly ventilated rooms and HVAC problems before they become catastrophic failures. Such a service does not currently exist within traditional building automation systems, which do not focus on indoor air quality or occupant comfort.

In some embodiments, the system and methods may be used in the prediction of events in other industries and other situations, beyond HVAC maintenance.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating an exemplary fault prediction and detection system in which some embodiments may operate.

FIG. 2A is a diagram illustrating an exemplary singular environmental sensor device in accordance with aspects of the present disclosure.

FIG. 2B is a diagram illustrating an exemplary aggregation node in accordance with aspects of the present disclosure.

FIG. 2C is a diagram illustrating an exemplary application server in accordance with aspects of the present disclosure.

FIG. 3A is a diagram illustrating an exemplary fault prediction architecture in accordance with aspects of the present disclosure.

FIG. 3B is a diagram illustrating an exemplary online fault prediction in accordance with aspects of the present disclosure.

FIG. 3C is a diagram illustrating an exemplary online mode identification in accordance with aspects of the present disclosure.

FIG. 3D is a diagram illustrating an exemplary offline learning in accordance with aspects of the present disclosure.

FIG. 4A shows an example interface of a fault prediction and detection system in accordance with aspects of the present disclosure.

FIG. 4B shows an example interface of a fault prediction and detection system in accordance with aspects of the present disclosure.

FIG. 4C shows an example interface of a fault prediction and detection system in accordance with aspects of the present disclosure.

FIG. 4D shows an example interface of a fault prediction and detection system in accordance with aspects of the present disclosure.

FIG. 4E shows an example interface of a fault prediction and detection system in accordance with aspects of the present disclosure.

FIG. 4F shows an example interface of a fault prediction and detection system in accordance with aspects of the present disclosure.

FIG. 5A is a flow chart illustrating an exemplary method that may be performed in accordance with some embodiments.

FIG. 5B is a flow chart illustrating an exemplary method that may be performed in accordance with some embodiments.

FIG. 6A is a flow chart illustrating an exemplary method that may be performed in accordance with some embodiments.

FIG. 6B is a flow chart illustrating an exemplary method that may be performed in accordance with some embodiments.

FIG. 7 is a diagram illustrating an exemplary computer that may perform processing in some embodiments and in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The following generally relates to a system and methods for detecting and predicting faults and failures in HVAC hardware based on external singular environmental sensor (SES) devices 105 and aggregation nodes 110.

In some embodiments, SES devices 105, aggregation nodes 110 and application server 115 may be used as a cloud-based architecture to bridge the gap between traditional building automation systems (BAS) and the variable climatic factors in a built environment. In some embodiments, no data about the mechanical system itself may be used in the identification and prediction of faulty modes of operation and failure of mechanical and hardware systems within the HVAC system. This information is generally proprietary and requires additional hardware to access from the BAS and control network (BAC net), and in some cases must be purchased. Instead, the fault prediction and detection system 100 may use external environmental data collected by the one or more sensors disposed within the one or more SES devices 105 and/or aggregation nodes 110.

Many sensors may be bundled or otherwise combined/integrated into a singular housing unit. In some embodiments, the SES devices are IoT devices, and may measure temperature, humidity, occupancy, total volatile organic compounds (TVOCs), equivalent CO2 (eCO2), pressure, and particle counts (i.e. PM2.5 and PM10) throughout each room in a building and send the data to the application server 115 over a network or cloud infrastructure. The SES devices 105 may be “edge devices” that connect to an aggregation node 110 or “gateway device” on a star-topology, low-powered wide area network (LPWAN) on the 915 Mhz frequency.

The aggregation nodes 110 may connect to the cloud and application server 115 via 4G network (LTE where available) with server-side security enforced via Identity Access Management (IAM). In some embodiments, data analysis and health management algorithms may run server-side in the cloud infrastructure (on application server 115 or other cloud based platforms), where situational-dependent emails and texts may be generated. Alerts may be curated on a personalized customer dashboard if a problem is detected or forecast to occur.

In some embodiments the system and method may be configured to detect HVAC system faults in real-time as well as predicting future performance of HVAC equipment without any sensor measurements from the equipment itself. Identification and prediction of faults and performance may be performed through the use of multivariate, multistep (patterns at multiple timescales) time-series analysis, as well as supervised and semi-unsupervised learning.

In some embodiments, training data may be generated from synthetic observations from limited real-world data regarding faulty HVAC conditions and IAQ issues. For example, one or more deep learning architectures may be combined with online stochastic simulation, and a human-in-the-loop component to create a robust framework that can identify HVAC and IAQ issues before they become major failures.

In some embodiments, the SES devices 105 may be used to measure the effects of the HVAC system on the environment, with noise, instead of actually taking measurements from the HVAC system and hardware itself. These measurements may be aggregated and analyzed to make predictions and determine performance of the HVAC system. The value of a hidden state may be inferred based on an observation with both uncertainty in the measurement and a probability distribution in the value of the state.

In some embodiments, environmental data may be obtained and/or generated while the HVAC system operates in both nominal and faulty conditions. Synthetically generated samples must closely resemble the class to which they belong.

In some embodiments, environmental variables may be used to identify appropriate representations and features necessary for clustering and successfully classifying data as nominal or faulty. A similarity metric may be used in the analysis of different operating modes.

In some embodiments, stochastic simulation may be used to generate a plurality of future estimates of the environmental measurements and predict if the system will be in a normal or faulty state. The stochastic simulation may account for noise and uncertainty, so that multiple samples can be forecasted to generate a distribution of the future state of the system. The generated distribution may then be compared to the distribution of the nominal mode, and the Mode Identification module may be triggered if they do not match.

In some embodiments, one or more composite long-short term memory (LSTM) architectures may be used in the training of predictive models and the detection of fault states. In some embodiments, a generative adversarial network (GAN) based network may be used to generate training samples, an autoencoder (AE) based network may be used to generate latent representations for clustering and classification, and a variational autoencoder (VAE) may be used to learn the parameters of a distribution. These networks may be integrated into a holistic framework that includes a human in the loop component and self-learning of new clusters, i.e. modes of operation. For example, these modes can be nominal, such as operating at different setpoints during periods of low occupancy versus high occupancy or operating at different setpoints due to different seasons, or they can be faulty, such as when a component in the HVAC system fails or when IAQ levels exceed dynamic thresholds.

In some embodiments, several modes of operation may be distinguished based on the SES devices 105 sensor readings and externally provided environmental data, such as weather data, solar radiance and other seasonal changes, as well as engineered features to encode various cyclical processes. In some embodiments, the one or more datasets are unlabeled datasets, and to correlate what happens in the environment with what is seen in the data, a semi-unsupervised learning approach may be used with human expert input for clustering.

In some embodiments, there may be an imbalance of data between normal operational data and true fault data. For example, the data set may be imbalanced most likely due to having an abundance of normal operational data but lack true fault data. In some embodiments, the imbalance may be addressed by increasing the amount of data collected. In some embodiments, an increase in the amount of data collected may be combined synthetic data generated by a neural network architecture that uses LSTM layers in a generative adversarial network (GAN). The GAN may be used to improve unsupervised learning tasks, and may be augmented with LSTM layers to increase performance on time-series data. This may allow for the building of a balanced, labeled dataset with a high degree of confidence that the labels are correct. The building of the balanced and labeled dataset may improving the performance of the detectors (classifiers) of each mode.

In some embodiments, one or more appropriate features may be identified or generated. The appropriate features may be features that offer maximum inter-cluster separation and minimum intra-cluster separation. An autoencoder may be used to generate better features than traditional feature selection approaches, improving the clustering of groups, and thereby the performance of the classifier trained on these groups. The autoencoder may be used for both clustering and classification.

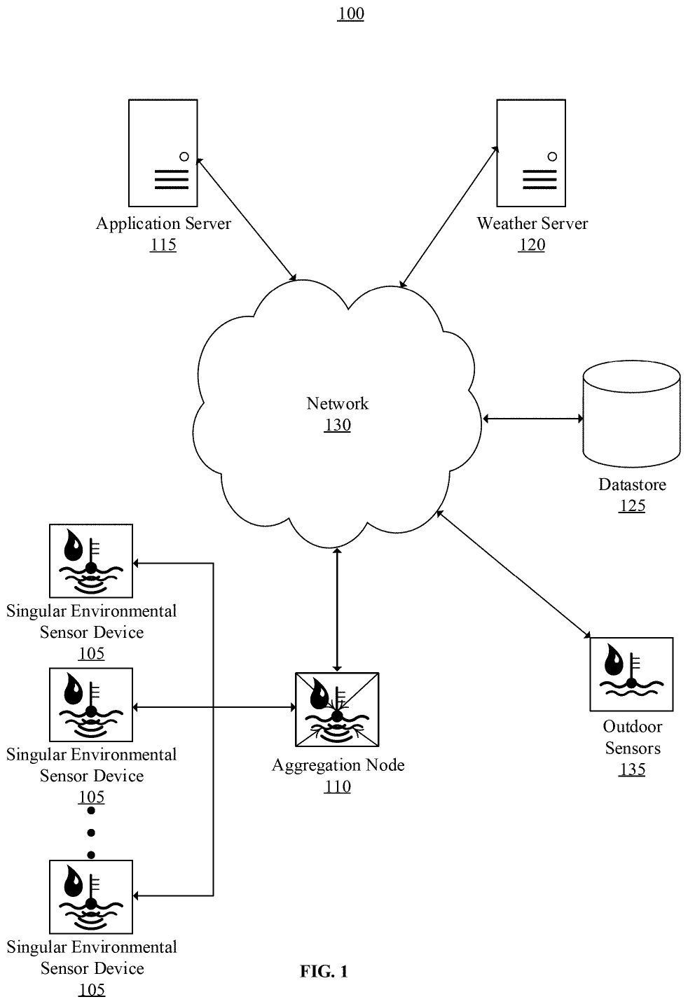

FIG. 1 is a diagram illustrating an exemplary fault prediction and detection system 100 in which some embodiments may operate. Fault prediction and detection system 100 may comprise one or more singular environmental sensor (SES) device 105, one or more aggregation nodes 110, one or more application servers 115, one or more weather servers 120, one or more datastores 125, one or more outdoor sensors 135 and a network 130.

SES devices 105 may read, record and/or transmit environmental sensor readings from the room in which the SES device 105 is installed in. The transmittal of the sensor readings may be transmitted to an aggregation node 110 at a predetermined interval. The SES devices 105 may take sensor readings at the same predetermined interval as transmission. In some embodiments, the SES devices 105 may take sensor readings at intervals shorter than the predetermined transmission interval and transmit all the recorded sensor readings taken between each transmission. In some embodiments, the SES devices may continually record sensor readings and transmit time-series data recorded during the time between transmissions. An SES device 105 may connect to another SES device 105 when unable to connect directly to an aggregation node 110. SES devices 105 may be configured to relay transmissions from other SES devices 105 when an aggregation node 110 is out of range, there is interference between the SES device 105 and aggregation node 110, repeated errors in transmission or other issues that may make reliable transmission of data impossible.

Aggregation nodes 110 may receive transmissions from one or more SES devices 105. In some embodiments, each aggregation node 110 may be in communication with a predetermined set of SES devices 105. In other embodiments, the aggregation nodes 110 may dynamically add and remove SES devices 105 from a communication list based on the receiving of a broadcast signal from each SES device 105. Aggregation nodes 110 may coordinate with each other to evenly distribute the responsibility of SES devices 105. Assignment of an SES device 105 to an aggregation node 110 may be based on the current list size of the aggregation node 110, signal strength between the SES device 105 and the aggregation node 110 or other communication or processing bottlenecks. For example, if an SES device 105 is in communications range of a two or more aggregation nodes 110, the SES device 105 may be assigned to an aggregation node 110 that is further away or has a weaker signal than the other aggregation nodes 110 based on the amount of resources available to the aggregation nodes 110 in range. Considerations other than resources and load balancing are also considered. For example, an aggregation node 110 with a weaker signal may be preferred over one with a stronger signal if the stronger signal is unreliable or unpredictable. In some embodiments that assignment of SES devices 105 to aggregation nodes 110 may be modified or changed based on time of day, predicted events, scheduled events or detected events. For example, at certain times of the day in a school, students change classes, go to lunch or go to auditoriums for events. These events may create changes in signal strength as the amount of interference caused by the occupants themselves or the activities they are participating in are constantly changing. Large groups of people may cause significant interference since there is a large mass of water (human body) that the transmissions must penetrate.

In some embodiments, each SES device 105 may be assigned to more than one aggregation node 110. This may be for redundancy of the entire system, or just select SES devices 105 that are identified as having an unreliable transmission history. The identification may be user selected or based off of analysis of transmission history.

Aggregation nodes 110 may transmit the sensor data received from the SES devices 105 as packaged aggregate data of all SES devices 105 or as packages of device specific of sensor data. Aggregate nodes 110 may be connected to the application server 115 by ethernet, WIFI, LTE or other 3GPP mobile communications technology.

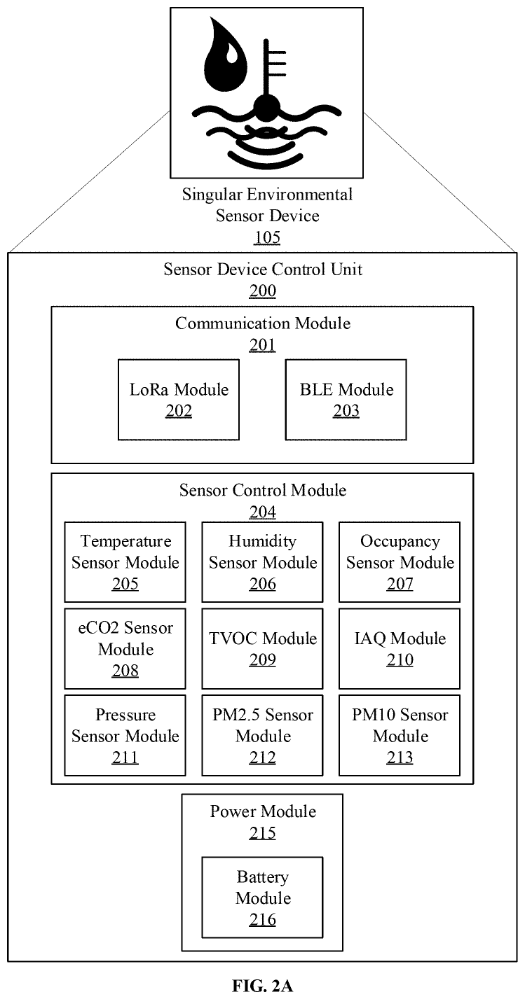

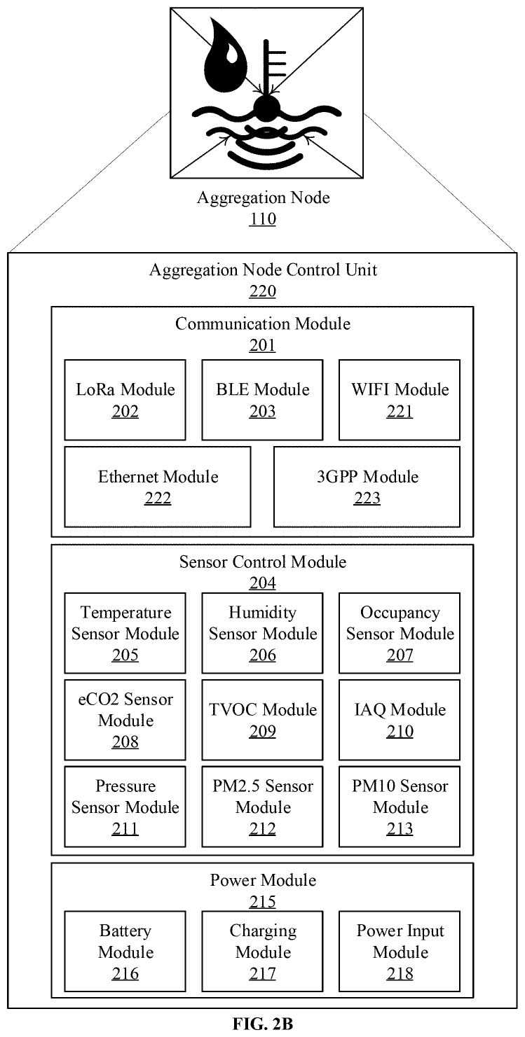

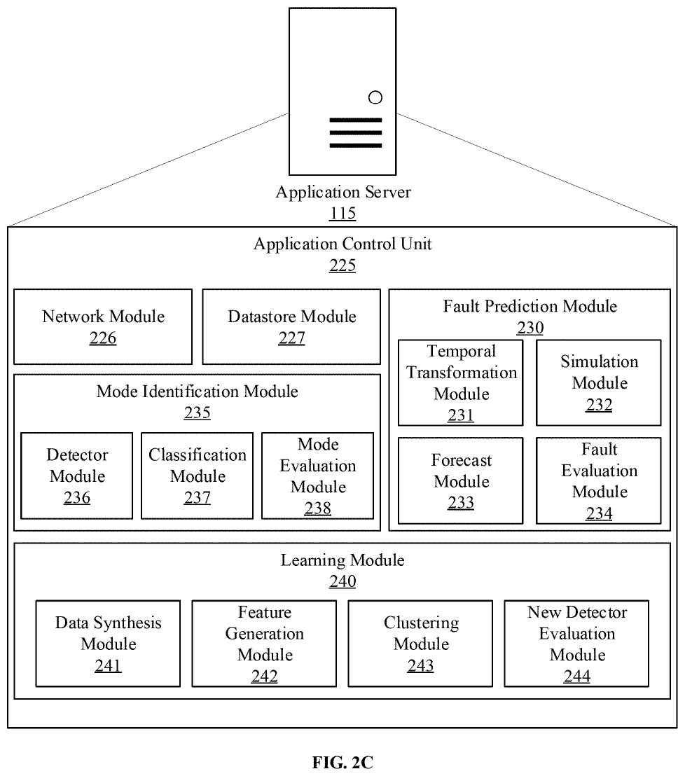

Application server 115 may be any computing device(s) capable of executing the operation of the fault prediction and detection system, including the operation of the modules of FIG. 2C. Application server 110 may be connected through a network 130 to the one or more aggregation nodes 110, one or more weather servers 120, one or more datastores 125 and one or more outdoor sensors 135.

Weather server 120 may be any system or service that provides weather and external environmental readings, forecasts or models. These datasets may be provided to the application server 115, and used in the prediction and performance modeling of the HVAC system and its mechanical/hardware parts. Weather server 120 may provide solar radiance, heat index and cloud cover data to better model the efficiency and performance of the HVAC system.

Outdoor sensors 135 may be similar to, or the same as the SES devices 105 or aggregation nodes 110. They may also include additional or different sensors that are designed for outdoor use. Additional sensor may include sensors for detecting solar radiance and wind speed. The outdoor sensors 135 may record and transmit sensor data directly to the application server 115 over the network 130, or transmit it to an aggregation node 110.

FIG. 2A is a diagram illustrating an exemplary SES device 105 in accordance with aspects of the present disclosure. SES device 105 may comprise, sensor device control unit 200. The sensor device control unit 200 may further comprise a communication module 201, a sensor control module 204 and a power module 215.

Communication module 201 may comprise a LoRa module 202 and BLE module 203. LoRa module 202 may be used to communicate with other SES devices 105 and aggregation nodes 110 across a greater distance and with much lower power consumption than WIFI and Bluetooth. BLE module may also be used for communication between SES devices 105 and aggregation nodes 110 as well as for initial installation, configuration and firmware update.

Sensor control module 204 may comprise temperature sensor module 205, humidity sensor module 206, occupancy sensor module 207, eCO2 sensor module 208, TVOC module 209, IAQ module 210, pressure sensor module 211, PM2.5 sensor module 212 and PM10 sensor module 213. Occupancy sensor module 207 may be an infrared or ultrasonic motion detection type sensor. The occupancy sensor module 207 may be any sensor that is capable of detecting an occupant. Other types of IAQ sensor may also be used in determining air quality.

Power module 215 may comprise a battery module 216. Battery module 216 may be a rechargeable or non-rechargeable power unit. The capacity of the unit may be determined based on the power requirements of the individual sensor, communications modules and communication frequency. In some embodiments, the battery module 216 may be of sufficient capacity to power the SES device 105 for more than a year.

FIG. 2B is a diagram illustrating an exemplary aggregation node 110 in accordance with aspects of the present disclosure. Aggregation node 110 may comprise an aggregation node control unit 220, a communication module 201, a sensor control module 204 and a power module 215. Sensor control module 204, power module 215 and battery module 216 are similar or the same as described above with regard to FIG. 2A.

Communication module 201 may comprise a LoRa module 202, a BLE module 203, a WIFI module 221, an ethernet module 222 and a 3GPP module 223. LoRa module 202 and BLE module 203 are similar or the same as described with regard to FIG. 2A. WIFI module 221 may be any module capable of receiving and transmitting according to 802.11ABGN standards or other WIFI standards. 3GPP module 223 may be configured to communicate over one or more mobile telecommunications standards such as LTE, GPRS, EDGE, HSPA, HSPA+, GSM, UMTS, 5G or any mobile telecommunications standard developed in the future.

Power module 215 may further comprise charging module 217 and power input module 218. Charging module 217 may be configured to receive electrical energy from the power input module 218 and facilitate/manage the charging of the battery module 216. Aggregation node 110 may be operated solely from the battery module 216, the power input module 218 or a combination thereof. The power input module 218 may connect directly to an electrical outlet, mains electrical circuits or through an adapter/converter/transformer used to condition the input voltage and frequency to that of the aggregation node 110. The power input module 218 may also comprise circuitry to convert from AC to DC as well as switching between different mains power standards.

FIG. 2C is a diagram illustrating an exemplary application server 115 in accordance with aspects of the present disclosure. Application server 115 may comprise an application control unit 225, network module 226, datastore module 227, a fault prediction module 230, a mode identification module 235 and a learning module 240.

Network module 226 may transmit and receive data from other computing systems via a network. In some embodiments, the network module 226 may enable transmitting and receiving data from the Internet. Data received by the network module 226 may be used by the other modules. The modules may transmit data through the network module 226.

Datastore module 227 may be a storage media, such as disk drives, solid state drives, tape drives, RAM, ROM, or anything other media that can be read from and written to. The datastore module 227 may comprise one or more structured or unstructured databases or other data structures. The datastore module 227 may be configured to store information received from aggregation nodes 110, weather servers 120, datastores 125 and outdoor sensors 135. Datastore module 227 may be connected to a cloud based or network-area storage solution (datastore 125). Datastore module 227 may store building information, SES device information, aggregation node information, room information, HVAC system information, maintenance history, client information, machine learning models, predictive models, energy consumption logs, as well as time-series data on the environments, from sensor readings, of one or more building and one or more rooms within the buildings.

Fault prediction module 230 may comprise a temporal transformation module 231, a simulation module 232, a forecast module 233 and a fault evaluation module 234. The temporal transformation module 231 may receive raw data samples recorded by the SES devices 105 and convert the data into a data structure which aligns a lookback period with a horizon period. The lookback period may be a period of time where the data samples are used for prediction. The horizon period may be the period of time that the data samples are projected into the future. These aligned data structure may be represented as temporal transformation blocks and used by the simulation module 232 in performing stochastic simulations. The temporal transformation module may be responsible for embedding the temporal characteristics into the data to account for changes over time. The temporal characteristics may be used in the training, retraining and feature extraction.

The simulation module 232 may perform one or more stochastic simulations based on the temporal transformation blocks received from the temporal transformation module 231. In some embodiments, a plurality of stochastic simulations may be performed. The number of simulations may be predetermined or based on the amount or quality of the received from the temporal transformation module 231. The simulation module 232 may incorporate noise and uncertainty into the one or more stochastic simulations. Different biases and variances may be used in the addition of noise and uncertainty. Noise may be additive and therefore may be positive or negative. In some embodiments, the standard error of the sensors may be used in generating the noise to be added to the stochastic simulation. The standard error of the sensors may be entered manually, pulled from a spreadsheet, a data sheet from the manufacturer or other source of sensor hardware specification. In some embodiments, a Gaussian distribution for white noise may be used in combination with the specified measurement errors (standard error) according to the sensor datasheet. In some embodiments, the simulation module may generate a set of samples by taking a smaller set of historic readings and creating a larger population based on the actual samples with additive noise. The historic readings may be the most recent readings (i.e. previous 5 readings) or pulled from a subset of readings but not necessarily chronologically adjacent. For example, in the case of using 5 readings to generate the larger dataset, instead of the most recent 5 readings, the simulation module 232 may choose any 5 readings from a subset of the historical readings. The subset may correspond to a predetermined period of time, such as blocks of time between 1 hour to one week or longer. The chosen readings may be chosen at random or may be chosen based on common environmental influences, such as similar weather at the time of reading, similar time, similar occupancy or combination thereof. The readings may also be chosen to create a more diverse dataset, such that the similarity between the 5 readings is minimized.

Forecast module 233 may receive multiple samples from the plurality of stochastic simulation performed by the simulation module 232. The synthetically generated samples, along with the actual sample, may then be used to generate a set of predictions. The predictions may be generated by passing each of the synthetically generated and actual sampled through a multi-step LSTM network. The forecast module 233 may then generate a distribution for the set of predictions and the current nominal mode. Nominal mode distributions may be learned offline, in an LSTM-VAE architecture.

The fault evaluation module 234 may receive the generated distributions from the forecast module 233 and compare them. The prediction distribution and the current nominal mode distribution may be compared through any means capable of comparing two entire distributions, such as the Kolmogorov-Smirnov (KS) test, through a comparison of single samples to a distribution, such as Z test, or combination thereof. The evaluation may trigger an online mode identification by the mode identification module 235 when the evaluation of the prediction distribution and the current nominal mode distribution do not conform (i.e. similarity score below a predetermined threshold or confidence level below a predetermined threshold).

Mode identification module 235 may comprise detector module 236, classification module 237 and mode evaluation module 238. Mode identification module 235 may be responsible for identifying the mode that corresponds to the predicted environmental conditions, and may be triggered when the values do not conform to the expected values given the current mode of operation. In some embodiments, when online mode identification is triggered, features and values generated by the forecast module may be multiplexed to one or more detector modules 236.

Each detector module 236 may be an LSTM-AE network trained on individual modes. Each detector module 236 may reconstruct a set of time series data from the features received from the forecast module 233. A reconstruction error or reconstruction score may then be determined based on similarity between the reconstructed data and the data received from the forecast module 233. Each reconstruction score may then be transferred to the classification module 237.

Classification module 237 may implement a federated classification framework. There may be a plurality of trained classifiers (detector modules 236), each trained to detect a single fault, failure or mode of operation. In a federated classification framework, the reconstruction errors of each classifier (detector module 236) may be compared against each other and to a predetermined threshold.

Mode evaluation module 238 may receive the reconstruction scores for each of detector modules 236. The detector module 236 with the lowest score that is also below the predetermined threshold may be accepted as the identified mode. If no detector module 236 has a reconstruction error/score below the threshold, the sample may be from an “unknown” mode, and an offline learning process is triggered in the learning module 240. If a detector module 236 has a reconstruction error/score below the threshold, the mode associated with that detector is determined to be the current operating mode of the system.

Learning module 240 may comprise, data synthesis module 241, feature generation module 242, clustering module 243 and new detector evaluation module 244. The learning module 240 may receive synthetic and actual sample data from the fault prediction module 230, temporal transformation module 231, simulation module 232, forecast module 233, fault evaluation module 234, mode identification module 235, detector module 236, classification module 237, mode evaluation module 238, datastore module 227 or from database 125. The learning module 240 may also use any clusters already discovered and/or features already generated.

Data synthesis module 241 may receive, clean, preprocess and generate data. In some embodiments, a generative adversarial network (GAN) may be used to generate training samples. Unknown samples may be labeled with a dummy label and updated when the mode has been learned.

Feature generation module 242 may receive the cleaned, preprocessed and generated data from the data synthesis module 241. An LSTM-AE may then be trained on the received dataset and used to generate a set of latent features (compressed representation of the original data).

Clustering module 243 may use the set of latent features from the feature generation module 242 to perform clustering. One or more clustering methods may be used to maximize inter-class distance and minimize intra-class distance. New detector evaluation module 244 may use the inter-class, intra-class distance or other evaluation metrics/tests to determine when an acceptance criteria is met. In some instances, different clustering methods and different parameters for those methods may be used to perform clustering, and the process may be iterated until the acceptance criteria has been met. When the acceptance criteria has been met, the new detector for the unknown mode may be saved. This process may be used to initially train the detectors for each mode, both nominal modes and fault modes, as well as updating detectors and creating detectors for newly discovered faults.

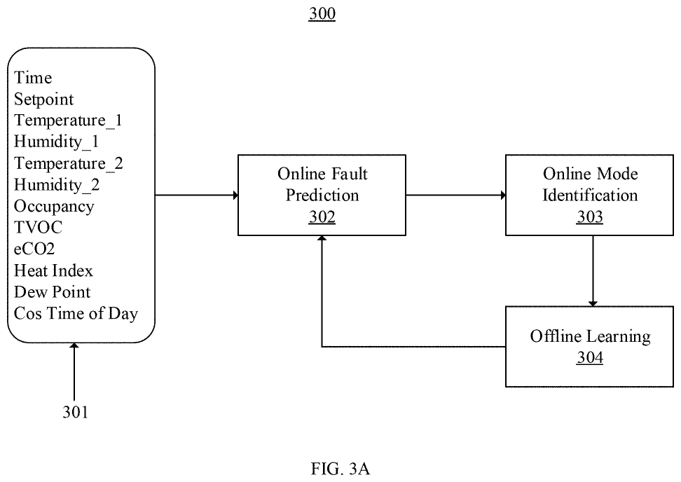

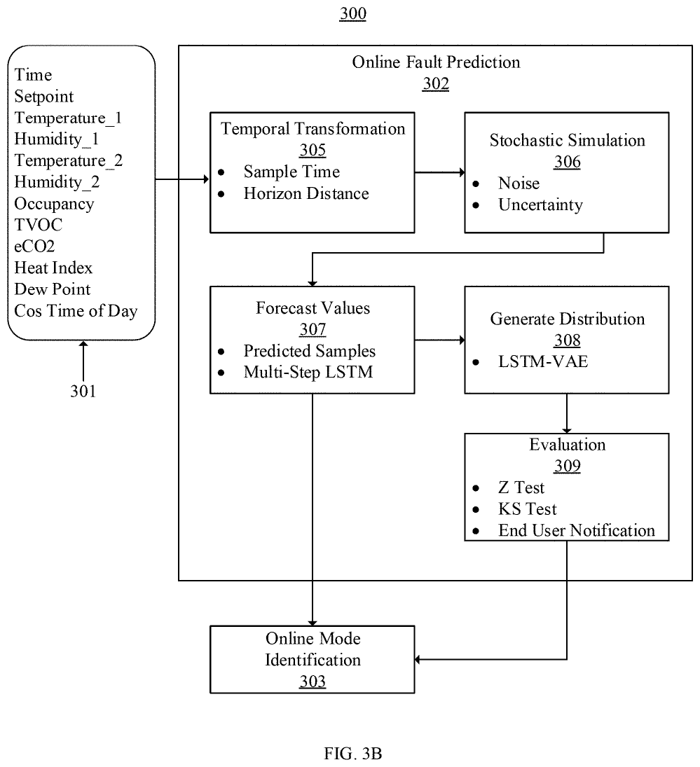

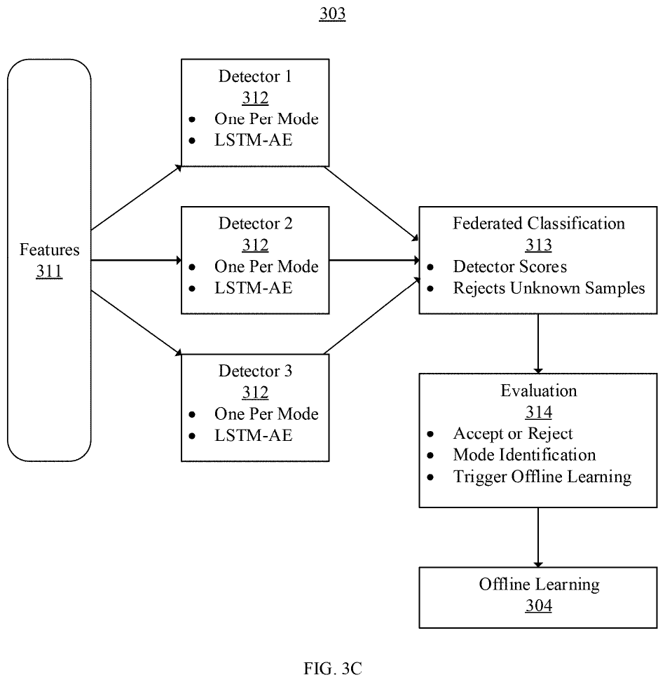

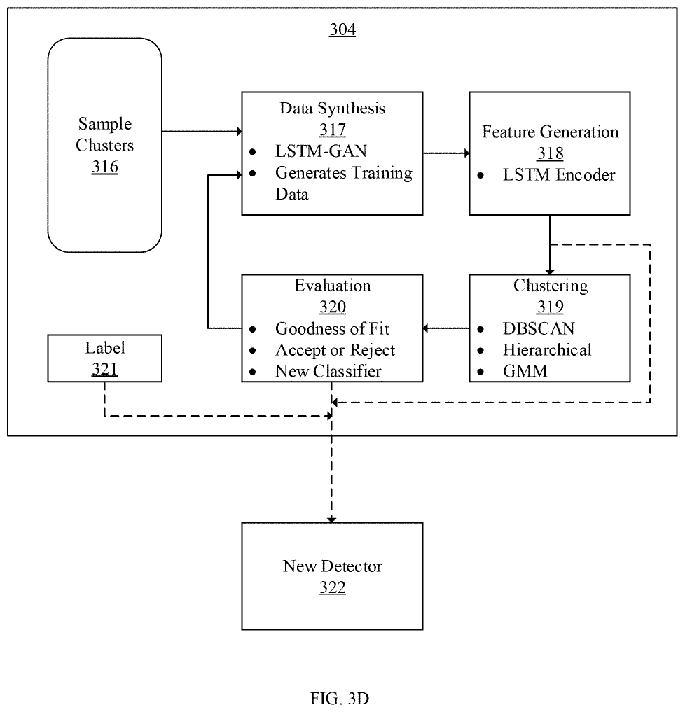

FIG. 3A is a diagram illustrating an exemplary fault prediction architecture 300 in accordance with aspects of the present disclosure. The fault prediction framework 300 may comprise three primary components, an Online Fault Prediction component 302, an Online Mode Identification component 303, and an Offline Learning component 304. The operation of the individual components are described in more detail above with regard to FIG. 2C, modules 230, 235 and 240, and below with regard to FIGS. 3B-3D. Sensor data 301 may be from one or more sources and may comprise readings from indoor sensors such as SES devices 105 and aggregation nodes 110, outdoor sensors 135, weather servers 120 or combination thereof. The sensor data may comprise measurements of time, setpoint, indoor temperature, indoor humidity, outdoor temperature, outdoor humidity, occupancy, TVOC, eCO2, heat index, dew point, cosine time of day, solar radiance, cloud cover, wind speed, weather models, weather forecasts, third party indoor and outdoor environmental data or combination thereof.

FIG. 3B is a diagram illustrating an exemplary online fault prediction component 302 in accordance with aspects of the present disclosure. Online fault prediction 302 may receive sensor data 301 from one or more aggregation nodes 110, weather server 120, datastore 125, outdoor sensors 135, locally stored data (datastore module 227) or combination thereof. Online fault prediction may comprise temporal transformation block 305, stochastic simulation block 306, forecast values block 307, generate distribution block 308 and an evaluation block 309.

The online fault prediction Online Fault Prediction component 302 may be responsible for predicting deviations in the environmental measurements that would be indicative of a fault or unknown mode of operation. The inputs to the fault prediction framework 300 may be raw data samples from the environment. In the temporal transformation block 305, the raw data may be converted into a data structure that aligns the “lookback” period (the period of time that data samples are used for prediction) with the “horizon” period (the period of time estimates are projected into the future). Then, in the stochastic simulation block 306, noise and random error (i.e. gaussian white noise and the specified measurement error according to the sensor datasheets) may be introduced to produce a set of observations to forecast from. In the forecast values block 307, each observation may be passed to a multi-step LSTM network to generate a set of predictions. Then, a distribution may be generated for the predictions and the current nominal mode in the generate distribution block 308. The generate distribution block 308 may be determine an appropriate distribution for noise and uncertainty and generate a distribution of samples.

An LSTM-VAE architecture may be used offline to learn the distribution of the nominal modes. The LSTM-VAE may also be used to learn fault modes, wherein the fault modes are learned from a single latent feature vector. Nominal modes may be learned from two or more vectors, representing the mean and standard deviation of the mode. The distributions may then be compared in the evaluation block 309 using the Kolmogorov-Smirnov (KS) test, which compares an entire distribution based on the cumulative distribution functions, and the Z test, which compares a single sample to a distribution. Upon evaluation by the evaluation block 309, if values do not conform to the expected values given the current mode of operation, the online mode identification component 303 may be triggered.

FIG. 3C is a diagram illustrating an exemplary online mode identification component 303 in accordance with aspects of the present disclosure. Online mode identification component 303 may comprise features 311, a plurality of detectors 312 (Detector 1, Detector 2 and Detector 3), a federated classification block 313 and an evaluation block 314. Features 311 may be passed from the online fault prediction component 302, to the online mode identification component 303, and then multiplexed to each of the plurality of detectors 312.

Online mode identification component 303 may be responsible for identifying the mode that corresponds to the predicted environmental conditions, and may only be triggered when the values do not conform to the expected values given the current mode of operation. This may reduce the amount of computational resources consumed as the system may operate in a normal operating mode the majority of the time, and thus these operations are not necessary. When the online mode identification is triggered, the features from the telemetry data are multiplexed to each detector 312, which may be LSTM-AE networks trained on individual modes. Then, in the federated classification block 313, the reconstruction errors of each mode may be compared against each other and to a predetermined threshold. The detector with the lowest score that is also below the threshold may be accepted as the identified mode in the evaluation block 314. If no detector 312 scores below the threshold, the evaluation block 314 may assume that the sample is from an “unknown” mode, and the offline learning component may be triggered 304.

FIG. 3D is a diagram illustrating an exemplary offline learning component 304 in accordance with aspects of the present disclosure. The offline learning component 304 may comprise a sample clusters block 316, a data synthesis block 317, a feature generation block 318, a clustering block 319 and an evaluation block 320.

The offline learning component 304 may receive inputs from the online mode identification component 303 or from data stored in database 125 or datastore 227. The inputs may be true samples collected and any clusters already discovered (sample clusters 316). Initially, this may be an empty set. Data cleaning, preprocessing, and synthesis take place next in the data synthesis block 317. A generative adversarial network may be used to generate training samples to balance the dataset. Any unknown samples may be appended with a dummy label 321 that will be later updated when the mode has been learned.

Next, the augmented dataset may be passed to the feature generation block 318, where a long-short term memory auto-encoder may be trained. The encoder portion may be used to generate a set of latent features, or a compressed representation of the original data, for clustering. The LSTM-AE based network used in the feature generation block 318 may be designed to compress the raw data into latent features and then reconstruct it with a low reconstruction error score. The latent feature vector extracted during compress is derived data, used as inputs by the clustering block 319.

The set of features may then be passed to the clustering block 319, to be clustered using different algorithms to find the best clusters that maximize inter-class distance and minimize intra-class distance. This process may take place in an iterative loop with the evaluation block 320, and when the acceptance criteria is met, the decoder may be saved as a new detector 322 for the unknown mode, saving the features from the feature generation block 318.

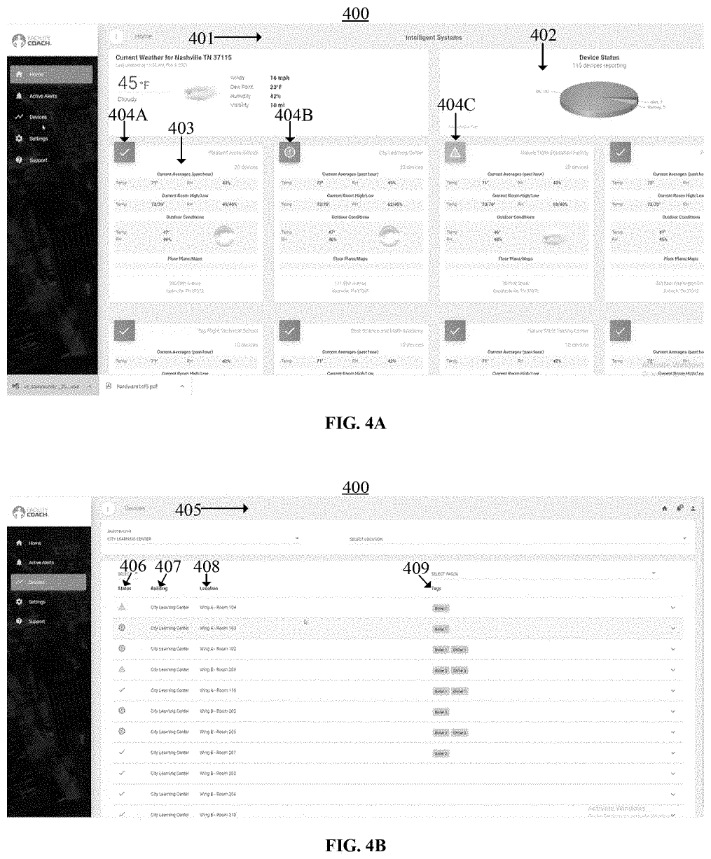

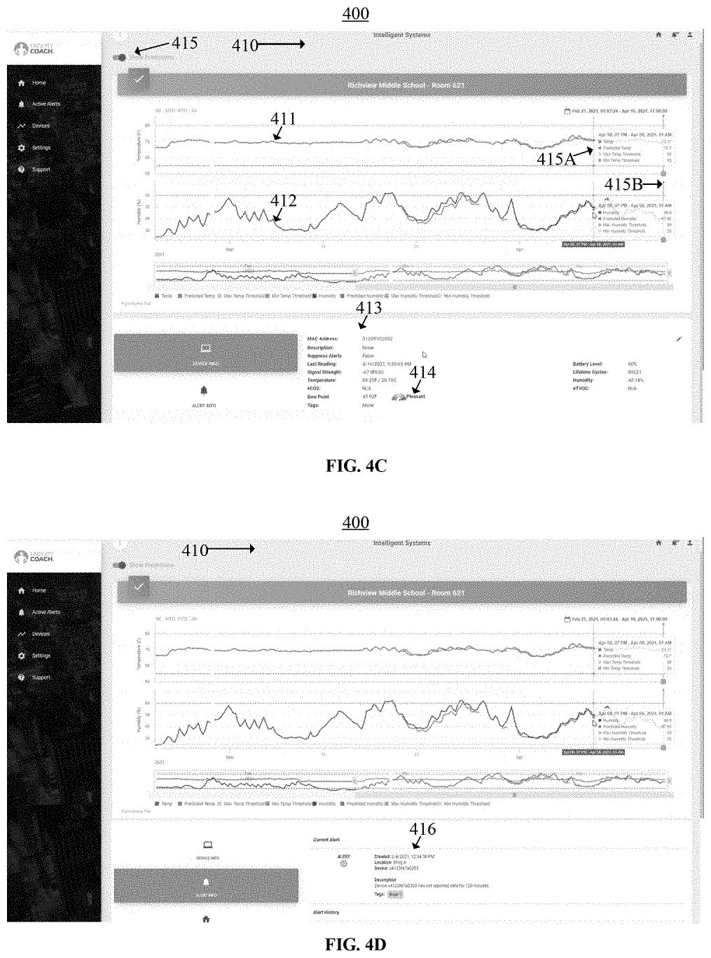

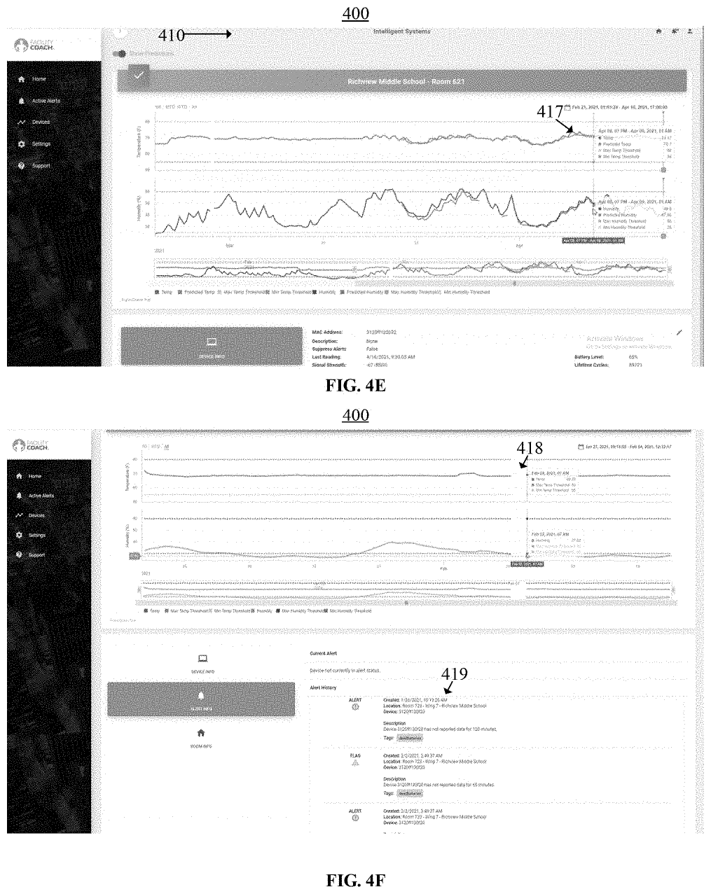

FIG. 4A shows an example interface of a fault prediction and detection system 400 in accordance with aspects of the present disclosure. The fault prediction and detection user interface 400 may comprise an overview dashboard 401, an overview device status indicator 402, one or more building status card 403, one or more normal function status icon 404A, one or more error status icon 404B and one or more warning status icon 404C.

The overview dashboard 401 may display user information, weather status for the users current location, device status, and an overview of the users current buildings.

The device status view 402 displays a color coded chart indicating the status of all devices for the user, where status can mean normal, threshold violation, communication failure, and so forth.

The building card 403 displays information for a given building such as weather data for that location, number of devices, and overall building status.

Icons 404A, 404B, and 404C are representative icons of status which increment in severity and may be color coded with class-identifying icons.

FIG. 4B shows an example interface of the user's device listing. Device listings 405 shows all the devices for a given user, where they can select and/or filter based on various options.

Device status indicator 406 shows the status of the device in accordance with the iconography set as above.

Building name 407 depicts the building name of the given device.

Room location 408 depicts the location in the building of the given device.

Tagged hardware 409 shows user-assigned tags for given devices, where tags may relate to HVAC components, locations with sensitive occupants, or for any purpose.

FIGS. 4C, 4D, 4E, and 4F depict example SES device 105 readings and room status in a room status interface 410. The room status interface 410 depicts graphs for environmental data such as temperature and humidity, but including others.

Room temperature plot 411 depicts the room temperature as well as the setpoint upper and lower thresholds.

Room humidity plot 412 depicts the room humidity as well as the setpoint upper and lower thresholds.

Device operating status 413 depicts device data and other sensor data captured by the SES device 105.

Sensor reading indicator 414 is an example of a discrete-gradient-based indicator to translate raw sensor readings into easily understood formats.

Prediction switch 415 may be used to enable visualization of the predictions.

Reading detailed view is shown in 415A, which shows the actual values at the given time based on the cursor location in the graph, as well as predicted values if they are enabled and available for that given time.

Now bar 415B is a vertical line that always depicts the present moment, whereby everything to the left of the line is past data, and everything to the right of the line are the future predicted values.

Predicted values 415C are shown to the right of the bar, and may be distinguishable from actual readings via color, shading, pattern or combination thereof.

Alert details 416 is a listing of alerts for the given device, where active/current alerts is a dynamic list and alert history is a static record that can only be manually cleared (but it is never deleted from the database).

Sensor reading spike 417 may be a depiction of the responsiveness of the sensors and times when the HVAC unit is turned on to blow warm air during heating season.

Sensor reading gap 418 shows that if the system does not get data for a certain period of time then it is not visualized.

Alert history 419 shows the alert history where it can be seen that a condition is first flagged, and then if it persists it becomes a warning. In this case, the warning was due to a loss in connectivity, which can be seen in 418.

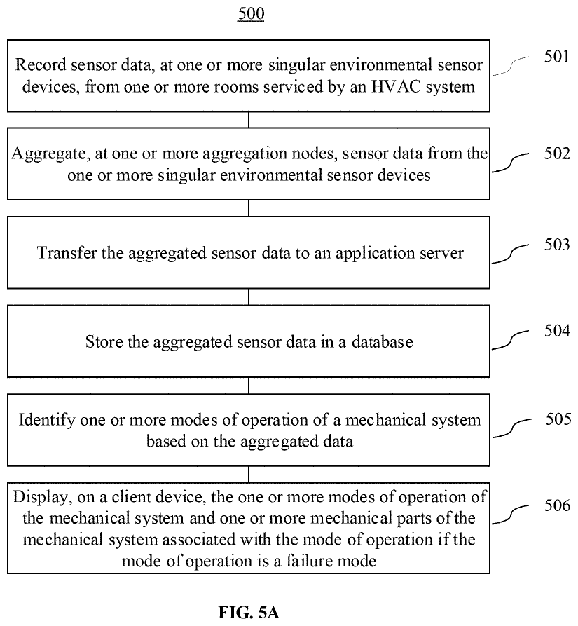

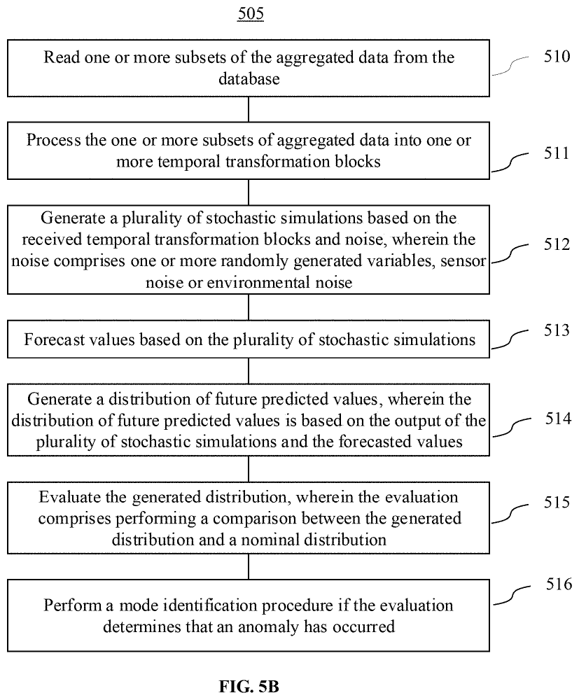

FIG. 5A is a flow chart illustrating an exemplary method that may be performed in accordance with some embodiments.

At step 501, the system may record sensor data, at one or more singular environmental sensor devices, from one or more rooms serviced by an HVAC system.

At step 502, the system may aggregate, at one or more aggregation nodes, sensor data from the one or more singular environmental sensor devices.

At step 503, the system may transfer the aggregated sensor data to an application server.

At step 504, the system may store the aggregated sensor data in a database.

At step 505, the system may identify one or more modes of operation of a mechanical system based on the aggregated data.

At step 506, the system may display, on a client device, the one or more modes of operation of the mechanical system and one or more mechanical parts of the mechanical system associated with the mode of operation if the mode of operation is a failure mode.

FIG. 5B is a flow chart illustrating an exemplary method to identify one or more modes of operation in an HVAC system that may be performed in accordance with some embodiments.

At step 510, the system may read one or more subsets of the aggregated data from the database.

At step 511, the system may process the one or more subsets of aggregated data into one or more temporal transformation blocks.

At step 512, the system may generate a plurality of stochastic simulation based on the received temporal transformation blocks and noise, wherein the noise comprises one or more randomly generated variables, sensor noise or environmental noise.

At step 513, the system may forecast values based on the plurality of stochastic simulations.

At step 514, the system may generate a distribution of future predicted values, wherein the distribution of future predicted values is based on the output of the plurality of stochastic simulations and the forecasted values.

At step 515, the system may evaluate the generated distribution, wherein the evaluation comprises performing a comparison between the generated distribution and a nominal distribution.

At step 516, the system may then perform a mode identification procedure if the evaluation determines that an anomaly has occurred.

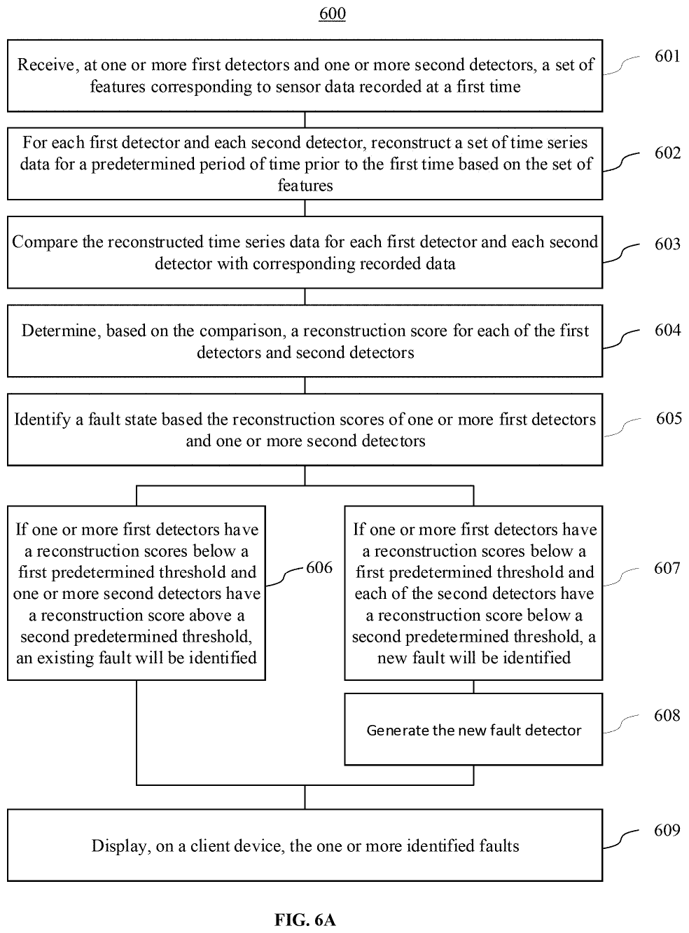

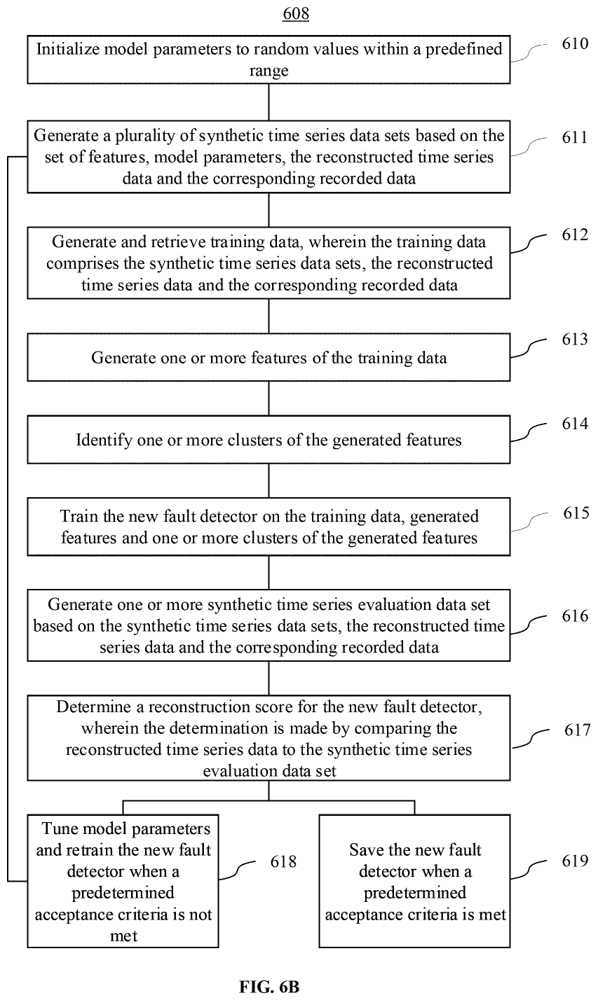

FIG. 6A is a flow chart illustrating an exemplary method for online mode identification in a that may be performed in accordance with some embodiments.

At step 601, the system may receive, at one or more first detectors and one or more second detectors, a set of features corresponding to sensor data recorded at a first time.

At step 602, the system may for each first detector and each second detector, reconstruct a set of time series data for a predetermined period of time prior to the first time based on the set of features.

At step 603, the system may compare the reconstructed time series data for each first detector and each second detector with corresponding recorded data.

At step 604, the system may determine, based on the comparison, a reconstruction score for each of the first detectors and second detectors.

At step 605, the system may identify a fault state based the reconstruction scores of one or more first detectors and one or more second detectors.

At step 606, the system may if one or more first detectors have a reconstruction scores below a first predetermined threshold and one or more second detectors have a reconstruction score above a second predetermined threshold, an existing fault will be identified.

At step 607, the system may if one or more first detectors have a reconstruction scores below a first predetermined threshold and each of the second detectors have a reconstruction score below a second predetermined threshold, a new fault will be identified.

At step 608, the system may generate the new fault detector.

At step 609, the system may display, on a client device, the one or more identified faults.

FIG. 6B is a flow chart illustrating an exemplary method for generating a new fault detector that may be performed in accordance with some embodiments.

At step 610, the system may initialize model parameters to random values within a predefined range.

At step 611, the system may generate a plurality of synthetic time series data sets based on the set of features, model parameters, the reconstructed time series data and the corresponding recorded data.

At step 612, the system may generate and retrieve training data, wherein the training data comprises the synthetic time series data sets, the reconstructed time series data and the corresponding recorded data.

At step 613, the system may generate one or more features of the training data.

At step 614, the system may identify one or more clusters of the generated features.

At step 615, the system may train the new fault detector on the training data, generated features and one or more clusters of the generated features.

At step 616, the system may generate one or more synthetic time series evaluation data set based on the synthetic time series data sets, the reconstructed time series data and the corresponding recorded data.

At step 617, the system may determine a reconstruction score for the new fault detector, wherein the determination is made by comparing the reconstructed time series data to the synthetic time series evaluation data set.

At step 618, the system may tune model parameters and retrain the new fault detector when a predetermined acceptance criteria is not met.

At step 619, the system may save the new fault detector when a predetermined acceptance criteria is met.

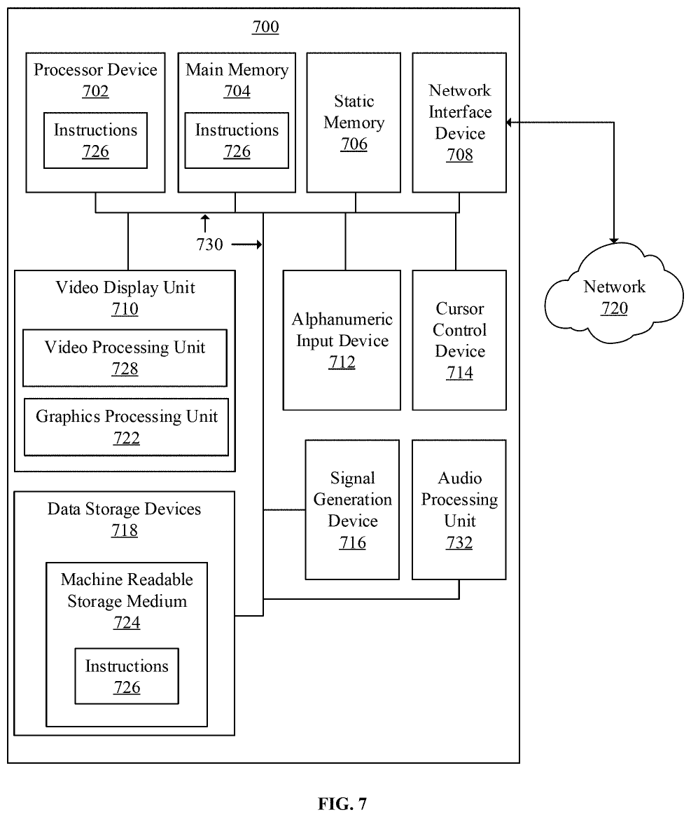

FIG. 7 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a computer-readable medium) on which is stored one or more sets of instructions or software 726 embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In one implementation, the instructions 726 include instructions to implement functionality corresponding to the components of a device to perform the disclosure herein. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for detecting and predicting faults of machinery in an HVAC system, the method comprising:
recording sensor data at one or more environmental sensor devices, wherein the one or more environmental sensor devices comprises:
a processor unit;
a memory unit;
a data storage unit;
a temperature sensor;
a humidity sensor;
an occupancy sensor;
an equivalent Carbon Dioxide sensor (eCO2);
a total volatile organic compound sensor (TVOC);
one or more particulate matter sensors; and
one or more network modules;
receiving at one or more aggregation nodes, the sensor data recorded by the one or more environmental sensor devices;
aggregating, at each aggregation node, the sensor data received by that aggregation node;
transferring, to an application server, the aggregated data from each of the aggregation nodes;
storing, at a database, the aggregated data;
identifying, at the application server, one or more modes of operation of a mechanical system based on the aggregated data; and
displaying, on a client device, one or more modes of operation; and
displaying one or more mechanical parts of the mechanical system associated with the mode of operation if the mode of operation is a failure mode.

2. The method according to claim 1, wherein the identifying comprises:
receiving, at one or more first detectors and one or more second detectors, a set of features corresponding to sensor data recorded at a first time, wherein the one or more first detectors are trained on sensor data recorded during normal operation and wherein the one or more second detectors are trained on sensor data recorded during faulty operation;
for each of the first detectors and second detectors, reconstruct a set of time series data for a predetermined period of time prior to the first time based on the set of features;
comparing the reconstructed time series data for each of the first detectors and second detectors with corresponding recorded data;
determining, based on the comparison, a reconstruction score for each of the first detectors and second detectors,
identifying a fault state based the reconstruction scores of one or more first detectors and one or more second detectors, wherein, if one or more first detectors have a reconstruction scores below a first predetermined threshold and each of the second detectors have a reconstruction score below a second predetermined threshold, a new fault will be identified.

3. The method according to claim 2, wherein a new fault detector is generated based on the identified new fault;
generating the new fault detector comprises:
generating a plurality of synthetic time series data sets based on the set of features, the reconstructed time series data and the corresponding recorded data;
training the new fault detector on training data, wherein the training data comprises the synthetic time series data sets, the reconstructed time series data and the corresponding recorded data;
wherein the training comprises:
generating features of the training data;
identifying one or more clusters of the generated features; and
evaluating the new fault detector, wherein the evaluation comprises:
generating one or more synthetic time series evaluation data set based on the synthetic time series data sets, the reconstructed time series data and the corresponding recorded data;
determining a reconstruction score for the new fault detector; and
saving the new fault detector when a predetermined acceptance criteria is met.

4. The method according to claim 1, wherein the identifying further comprises:
reading one or more subsets of the aggregated data from the database;
processing the one or more subsets of aggregated data into one or more temporal transformation blocks;
analyzing the one or more temporal transformation blocks, wherein the analyzing comprises:
performing a plurality of stochastic simulations, wherein the stochastic simulations comprise:
receiving the one or more temporal transformation blocks; and
generating a plurality of stochastic simulation based on the received temporal transformation blocks and noise, wherein the noise comprises one or more randomly generated variables, sensor noise or environmental noise;

5. The method according to claim 4, wherein the identifying further comprises:
predicting one or more values at a later point in the time, wherein the predicting comprises:
generating a distribution of future predicted values, wherein the distribution of future predicted values is based on the output of the plurality of stochastic simulations,
forecasting values based on the generated distribution; and
evaluating the forecast values, wherein the evaluating of the forecast values comprises performing a comparison between value distribution and the distribution of the nominal mode.

6. The method according to claim 1, wherein the receiving, aggregating and transferring occur at a predetermined interval.

7. A system comprising one or more processors, and a non-transitory computer-readable medium including one or more sequences of instructions that, when executed by the one or more processors, cause the system to perform operations comprising:
recording, at one or more environmental sensor devices, sensor data, wherein the one or more environmental sensor devices comprises:
a processor unit;
a memory unit;
a data storage unit;
a temperature sensor;
a humidity sensor;
an occupancy sensor;
an equivalent Carbon Dioxide sensor (eCO2);
a total volatile organic compound sensor (TVOC);
one or more particulate matter sensors; and
one or more network modules;
receiving, at one or more gateway devices, the sensor data recorded by the one or more environmental sensor devices;
aggregating, at each gateway device, the sensor data received by that gateway device;
transferring, to an application server, the aggregated data from each of the gateway devices;
storing, at a database, the aggregated data;
identifying, at the application server, one or more modes of operation of one or more mechanical parts of an HVAC system based on the aggregated data; and
displaying, on a client device, the one or more mechanical parts and one or more modes of operation associated with each mechanical part.

8. The system according to claim 7, wherein the identifying comprises:
receiving, at one or more first detectors and one or more second detectors, a set of features corresponding to sensor data recorded at a first time, wherein the one or more first detectors are trained on sensor data recorded during normal operation and wherein the one or more second detectors are trained on sensor data recorded during faulty operation;
for each of the first detectors and second detectors, reconstruct a set of time series data for a predetermined period of time prior to the first time based on the set of features;
comparing the reconstructed time series data for each of the first detectors and second detectors with corresponding recorded data;
determining, based on the comparison, a reconstruction score for each of the first detectors and second detectors,
identifying a fault state based the reconstruction scores of one or more first detectors and one or more second detectors, wherein, if one or more first detectors have a reconstruction scores below a first predetermined threshold and each of the second detectors have a reconstruction score below a second predetermined threshold, a new fault will be identified.

9. The system according to claim 8, wherein a new fault detector is generated based on the identified new fault;
generating the new fault detector comprises:
generating a plurality of synthetic time series data sets based on the set of features, the reconstructed time series data and the corresponding recorded data;
training the new fault detector on training data, wherein the training data comprises the synthetic time series data sets, the reconstructed time series data and the corresponding recorded data;
wherein the training comprises:
generating features of the training data;
identifying one or more clusters of the generated features; and
evaluating the new fault detector, wherein the evaluation comprises:
generating one or more synthetic time series evaluation data set based on the synthetic time series data sets, the reconstructed time series data and the corresponding recorded data;
determining a reconstruction score for the new fault detector; and
saving the new fault detector when a predetermined acceptance criteria is met.

10. The system according to claim 7, wherein the identifying further comprises:
reading one or more subsets of the aggregated data from the database;
processing the one or more subsets of aggregated data into one or more temporal transformation blocks;
analyzing the one or more temporal transformation blocks, wherein the analyzing comprises:
performing a plurality of stochastic simulations, wherein the stochastic simulations comprise:
receiving the one or more temporal transformation blocks; and
generating a plurality of stochastic simulation based on the received temporal transformation blocks and noise, wherein the noise comprises one or more randomly generated variables, sensor noise or environmental noise;

11. The system according to claim 10, wherein the identifying further comprises:
predicting one or more values at a later point in the time, wherein the predicting comprises:
generating a distribution of future predicted values, wherein the distribution of future predicted values is based on the output of the plurality of stochastic simulations,
forecasting values based on the generated distribution; and
evaluating the forecast values, wherein the evaluating of the forecast values comprises performing a comparison between the forecast values and one or more expected values.

12. The system according to claim 7, wherein the receiving, aggregating and transferring occur at a predetermined interval.
